(19) United States
(12) Patent Application Publication
(10) Pub. No.: US 2012/0288288 A1
(43) Pub. Date: Nov. 15, 2012

(54) IMAGE FORMING APPARATUS, POWER SUPPLY METHOD, AND COMPUTER-READABLE STORAGE MEDIUM

(76) Inventor: Yuuki IMAIZUMI, Kanagawa (JP)

(21) Appl. No.: 13/449,942

(22) Filed: Apr. 18, 2012

(30) Foreign Application Priority Data
May 10, 2011 (JP) 2011-105531

(51) Int. Cl. G03G 15/00

(52) U.S. Cl. 399/38

(57) ABSTRACT

An image forming apparatus includes an image forming unit configured to form an image on a medium; a control unit configured to control the image forming unit; a power supply unit configured to supply power from a commercial power source; a power generating unit configured to generate power that is separate from the power supplied from the commercial power source; and a secondary battery charged by the power generated by the power generating unit. The control unit switches a power source between the power supply unit and the secondary battery, the power source supplying power to at least the control unit.

### CROSS-REFERENCE TO RELATED APPLICATIONS

The present application claims priority to and incorporates by reference the entire contents of Japanese Patent Application No. 2011-105531 filed in Japan on May 10, 2011.

### BACKGROUND OF THE INVENTION

1. Field of the Invention

The present invention relates to an image forming apparatus, a power supply method for the image forming apparatus, and a computer-readable storage medium.

2. Description of the Related Art

Conventionally, there is a known image forming apparatus that can switch between a normal mode that performs printing and an energy-saving mode that stops power supply to an image forming unit for forming an image on a medium not to perform printing. For example, Japanese Patent Application Laid-open No. 2009-222824 discloses a technology for supplying power from a commercial power source to an image forming apparatus in the normal mode and supplying power from a secondary battery to the image forming apparatus, instead of supplying power from the commercial power source, in the energy-saving mode.

However, in the technology disclosed in Japanese Patent Application Laid-open No. 2009-222824, the secondary battery is charged by power from the commercial power source. Therefore, it is impossible to reduce the power consumption of the commercial power source. Furthermore, if the charging efficiency is taken into account, the power consumption of the commercial power source rather increases.

Therefore, there is a need for an image forming apparatus, a power supply method for the image forming apparatus, and a computer-readable storage medium, capable of reducing the power consumption of a commercial power source.

### SUMMARY OF THE INVENTION

It is an object of the present invention to at least partially solve the problems in the conventional technology.

According to an embodiment, there is provided an image forming apparatus that includes an image forming unit configured to form an image on a medium; a control unit configured to control the image forming unit; a power supply unit configured to supply power from a commercial power source; a power generating unit configured to generate power that is separate from the power supplied from the commercial power source; and a secondary battery charged by the power generated by the power generating unit. The control unit switches a power source between the power supply unit and the secondary battery, the power source supplying power to at least the control unit.

According to another embodiment, there is provided a power supply method for an image forming apparatus that includes an image forming unit configured to form an image on a medium, a control unit configured to control the image forming unit, a power supply unit configured to supply power from a commercial power source, a power generating unit configured to generate power that is separate from the power supplied from the commercial power source, and a secondary battery charged by the power generated by the power generating unit. The power supply method includes switching a power source between the power supply unit and the secondary battery, the power source supplying power to at least the control unit.

According to still another embodiment, there is provided a non-transitory computer-readable storage medium with an executable program stored thereon, wherein the program instructs an image forming apparatus that includes an image forming unit configured to form an image on a medium, a control unit configured to control the image forming unit, a power supply unit configured to supply power from a commercial power source, a power generating unit configured to generate power that is separate from the power supplied from the commercial power source, and a secondary battery charged by the power generated by the power generating unit, to perform switching a power source between the power supply unit and the secondary battery, the power source supplying power to at least the control unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a configuration example of an image forming apparatus;

FIG. 2 is a schematic diagram for explaining examples of various modes of the image forming apparatus;

FIG. 3 is a diagram illustrating an example in which a power source is switched to a power supply unit and the power supply unit supplies power to a main controller and an image forming unit;

FIG. 4 is a diagram illustrating an example in which the power source is switched to a secondary battery and the secondary battery supplies power to only the main controller;

FIG. 5 is a diagram illustrating an example in which the power source is switched to the power supply unit and the power supply unit supplies power to only the main controller;

FIG. 6 is a flowchart of an exemplary flow of a series of processes performed by a control unit;

FIG. 7 is a diagram illustrating an example in which the secondary battery is charged by power from the power supply unit; and

FIG. 8 is a diagram illustrating an example of a change in the operating state of the image forming apparatus over time.

### DETAILED DESCRIPTION OF THE PREFERRED EMBODIMENTS

An exemplary embodiment of an image forming apparatus and a power supply method for the image forming apparatus according to the present invention will be explained in detail below with reference to the accompanying drawings. In the following embodiment, an example is explained in which a multifunction peripheral having at least one of a copier function, a printer function, a scanner function, and a facsimile function is used as the image forming apparatus; however, the present invention is not limited thereto.

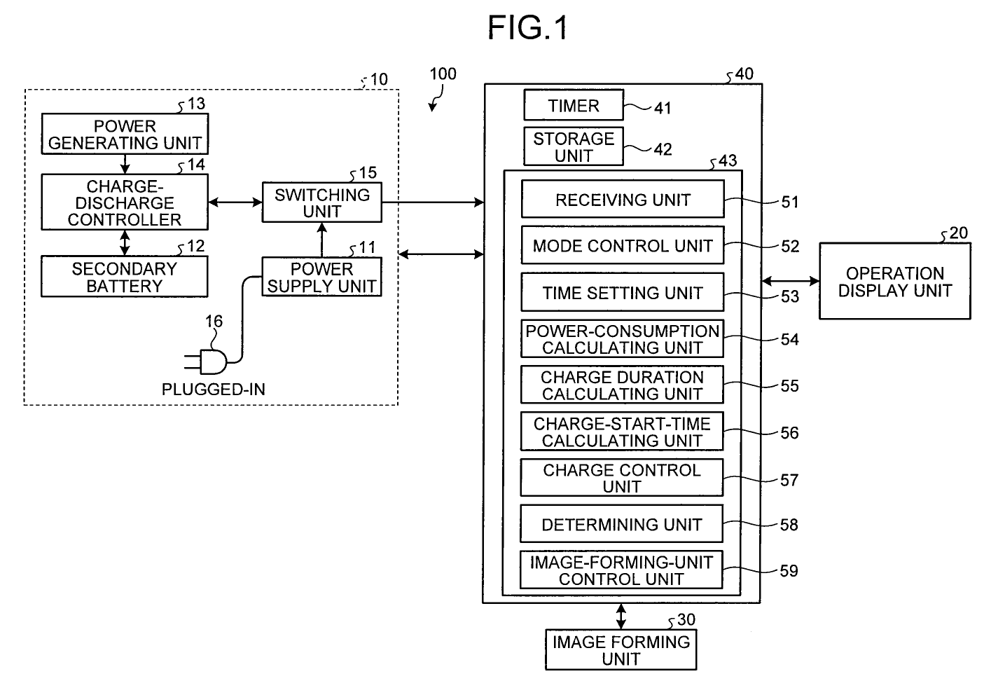

FIG. 1 is a diagram schematically illustrating a configuration example of an image forming apparatus 100. As illustrated in FIG. 1, the image forming apparatus 100 includes a power source unit 10, an operation display unit 20, an image forming unit 30, and a main controller 40.

As illustrated in FIG. 1, the power source unit 10 includes a power supply unit 11, a secondary battery 12, a power generating unit 13, a charge-discharge controller 14, and a switching unit 15. The power supply unit 11 is configured to supply power from a commercial power source (an AC power source). In the embodiment, the power supply unit 11 converts an alternating-current voltage supplied from the commercial power source to a direct-current voltage that is usable by the main controller 40 and the image forming unit 30. In the embodiment, the power supply unit 11 also includes a plug 16 that can be plugged in an outlet through which power is supplied from the commercial power source. When the plug 16 is plugged in the outlet, the power supply unit 11 and the commercial power source are connected to each other, so that power is supplied to the power supply unit 11 from the commercial power source.

The secondary battery 12 is a battery that can charge and discharge. The power generating unit 13 is configured to generate power separate (independent) from the power supplied from the commercial power source. In the embodiment, the power generating unit 13 includes a solar battery. The power generated by the power generating unit 13 is supplied to the secondary battery 12 via the charge-discharge controller 14. Accordingly, the secondary battery 12 is charged by the power generated by the power generating unit 13.

The charge-discharge controller 14 is configured to control charge and discharge of the secondary battery 12 under the control of the main controller 40. In the embodiment, the charge-discharge controller 14 can also detect the amount of charge (remaining charge) of the secondary battery 12. The charge-discharge controller 14 detects the amount of charge of the secondary battery 12 by using a well-known method. For example, the charge-discharge controller 14 can detect the amount of charge of the secondary battery 12 based on an electric-current integrated value of the secondary battery 12 and a capacity decay rate that is calculated from the temperature or the number of charges of the secondary battery 12. The method to detect the amount of charge of the secondary battery 12 is not limited to the above and any other method may be used.

The switching unit 15 is configured to select a power source that supplies power to at least the main controller 40, under the control of the main controller 40. For example, the switching unit 15 can switch the power source to the power supply unit 11 or to the secondary battery 12. The switching unit 15 can also select a power supply destination under the control of the main controller 40. For example, the switching unit 15 can select both of the main controller 40 and the image forming unit 30 or only the main controller 40 as the power supply destination.

In the embodiment, the charge-discharge controller 14 and the switching unit 15 can cause the power supply unit 11 to supply power or stop power supply to the secondary battery 12, under the control of the main controller 40. When the secondary battery 12 is charged by power from the power supply unit 11, the main controller 40 controls the switching unit 15 and the charge-discharge controller 14 so that power from the power supply unit 11 can be supplied to the secondary battery 12 via the charge-discharge controller 14.

The operation display unit 20 is configured to display various screens and information related to the image forming apparatus 100 and allow input of various operations from a user. The operation display unit 20 includes, although details are not illustrated in the figures, a display panel, which displays various screens and information related to the image forming apparatus 100 and receives touch input from a user; and an operating device, such as keys.

The image forming unit 30 is configured to form an image on a medium, such as a recording sheet, under the control of the main controller 40. In the embodiment, the image forming unit 30 is provided with at least toners for C, M, Y, and K and includes image forming units each including a photosensitive element, a charging device, a developing device, and a photosensitive element cleaner for each of the toners; an exposing unit; and a fixing device. The image forming unit 30 causes the exposing unit to emit light beams in accordance with received image data, so that toner images of the respective colors (C, M, Y, and K) are formed on the photosensitive elements. The image forming unit 30 transfers the toner images of the respective colors formed on the photosensitive elements onto a transfer sheet in a superimposed manner. The toner image transferred on the transfer sheet is fixed by heat and pressure applied by the fixing device. As a result, the image is formed on the transfer sheet as a desired printed matter. The configuration of the image forming unit 30 as described above is widely known; therefore, the details thereof will not be explained herein.

The main controller 40 is configured to control the entire image forming apparatus 100. As illustrated in FIG. 1, the main controller 40 includes a timer 41, a storage unit 42, and a control unit 43. The timer 41 is configured to measure a time. For example, the timer 41 may include a real-time clock function for measuring the current time. The storage unit 42 is configured to store various types of data (e.g., event information to be described later).

The control unit 43 is configured to control each of the units of the image forming apparatus 100, and is a computer that includes a central processing unit (CPU), a read only memory (ROM), a random access memory (RAM), and more. As illustrated in FIG. 1, the control unit 43 includes, as the functions thereof, a receiving unit 51, a mode control unit 52, a time setting unit 53, a power-consumption calculating unit 54, a charge duration calculating unit 55, a charge-start-time calculating unit 56, a charge control unit 57, a determining unit 58, and an image-forming-unit control unit 59. These functions are realized by causing the CPU of the control unit 43 to execute a predetermined control program stored in the ROM or the like; however, it is not limited thereto. For example, it may be possible to realize at least a part of the above functions by an individual circuit (hardware).

The receiving unit 51 receives various types of input from the operation display unit 20, an external apparatus (not illustrated), or the like. The various types of input include input of a print job and input of settings of a start and end time of a night energy-saving standby mode to be described later. The print job is a command signal for requesting printing of print data contained in the print job. The number of pieces of the print data (the number of sheets to be printed) contained in the print job may be set on demand. The print data is written in, for example, a page description language (PDL). The print job may be regarded as an image formation request for requesting the image forming unit 30 to form an image.

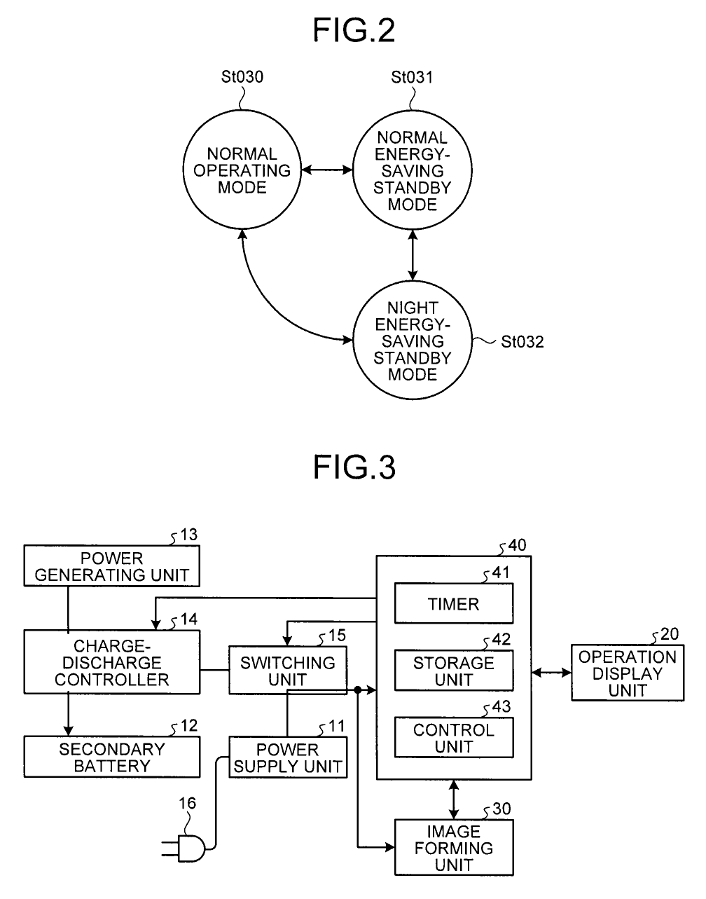

The mode control unit 52 controls entry to and exit from each of modes that indicate different operating states of the image forming apparatus 100. As illustrated in FIG. 2, a normal operating mode St030, a normal energy-saving standby mode St031, and a night energy-saving standby mode St032 are provided as the modes of the image forming apparatus 100 of the embodiment. The normal operating mode St030 indicates the operating state of the image forming apparatus 100 when the image forming unit 30 performs printing (image formation). In the normal operating mode St030, both of the main controller 40 and the image forming unit 30 operate, so that the power consumption increases. Therefore, in the normal operating mode St030, as illustrated in FIG. 3, the main controller 40 (the mode control unit 52) controls the switching unit 15 and the charge-discharge controller 14 so that the power source is switched to the power supply unit 11 and the power supply unit 11 supplies power to both of the main controller 40 and the image forming unit 30. Power generated by the power generating unit 13 is supplied to the secondary battery 12 via the charge-discharge controller 14. However, during a time when the irradiance of the sun is lower than a threshold, e.g., the nighttime, the power generating unit 13 cannot generate power. In this case, the power generating unit 13 does not supply power to the secondary battery 12 (the charge-discharge controller 14). The same is applied to the other modes.

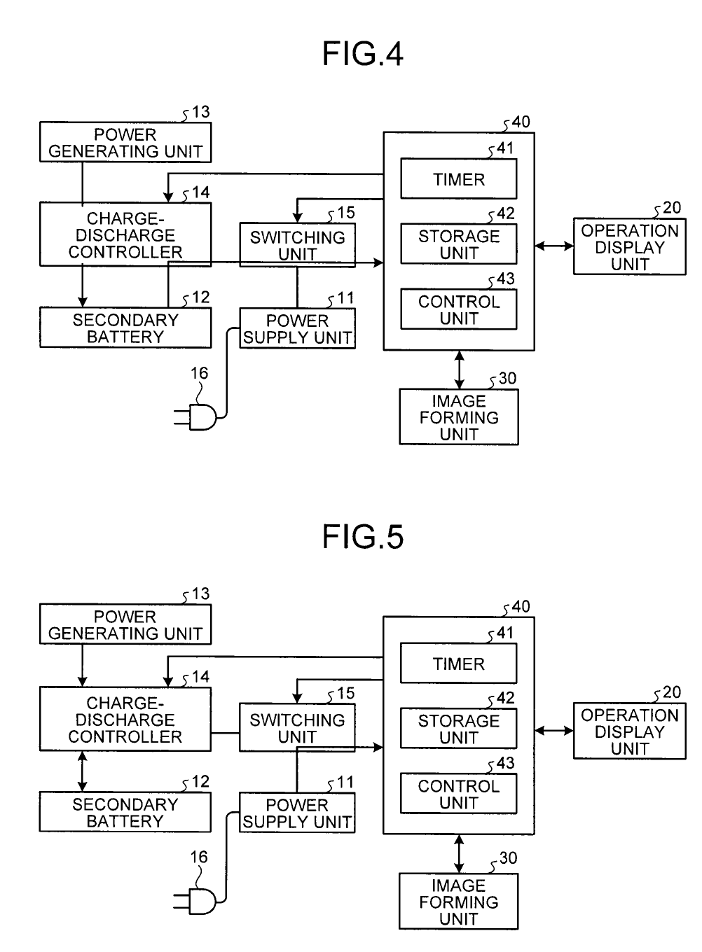

The normal energy-saving standby mode St031 indicates the operating state of the image forming apparatus 100 when the image forming unit 30 does not perform printing during a time (daytime) other than the time (nighttime) during which the night energy-saving standby mode St032 is set. In the normal energy-saving standby mode St031, the image forming unit 30 does not operate and only the main controller 40 operates; therefore, power is supplied to only the main controller 40. In the embodiment, the power source is switched depending on the amount of charge of the secondary battery 12. Specifically, when the amount of charge of the secondary battery 12 is equal to or greater than a reference value, as illustrated in FIG. 4, the main controller 40 (the mode control unit 52) controls the switching unit 15 and the charge-discharge controller 14 so that the power source is switched to the secondary battery 12 and the secondary battery 12 supplies power to only the main controller 40. On the other hand, when the amount of charge of the secondary battery 12 is smaller than the reference value, as illustrated in FIG. 5, the main controller 40 (the mode control unit 52) controls the switching unit 15 and the charge-discharge controller 14 so that the power source is switched to the power supply unit 11 and the power supply unit 11 supplies power to only the main controller 40.

When the secondary battery 12 is charged by power from the power supply unit 11, the main controller 40 (the mode control unit 52) controls the switching unit 15 and the charge-discharge controller 14 so that the power source is switched to the power supply unit 11 and the power supply unit 11 supplies power to only the main controller 40 regardless of the amount of charge of the secondary battery 12. Furthermore, the control unit 43 (the charge control unit 57) controls the switching unit 15 and the charge-discharge controller 14 so that the power supply unit 11 supplies power to the secondary battery 12.

The night energy-saving standby mode St032 indicates the operating state of the image forming apparatus 100 when the image forming unit 30 does not perform printing during the nighttime. Hours to be regarded as the nighttime are set by the time setting unit 53 in advance. In the night energy-saving standby mode St032, the image forming unit 30 does not operate and only the main controller 40 operates; therefore, power is supplied to only the main controller 40. However, this mode is different from the normal energy-saving standby mode St031 in that only the secondary battery 12 serves as the power source. Specifically, in the night energy-saving standby mode St032, as illustrated in FIG. 4, the main controller 40 (the mode control unit 52) controls the switching unit 15 and the charge-discharge controller 14 so that the power source is switched to the secondary battery 12 and the secondary battery 12 supplies power to only the main controller 40.

The time setting unit 53 sets a night-energy-saving-standby-mode start time indicating a time at which the night energy-saving standby mode St032 is entered, and sets a night-energy-saving-standby-mode end time indicating a time at which the night energy-saving standby mode St032 is exited.

The power-consumption calculating unit 54 calculates a night-energy-saving-standby-mode power amount that indicates the power consumption when the night energy-saving standby mode St032 is maintained for a duration set by the time setting unit 53 (i.e., for a duration from the night-energy-saving-standby-mode start time to the night-energy-saving-standby-mode end time). The charge duration calculating unit 55 calculates, based on the amount of charge of the secondary battery 12 and the amount of power generated by the power generating unit 13, a charge duration indicating a time needed to increase the amount of charge of the secondary battery 12 to a predetermined value that is equal to or greater than the night-energy-saving-standby-mode power amount when the secondary battery 12 is charged by power from the power supply unit 11. The charge-start-time calculating unit 56 calculates a time that is earlier than the night-energy-saving-standby-mode start time by the charge duration, as a charge start time indicating a time at which the power supply unit 11 starts charging the secondary battery 12. When the charge start time comes, the charge control unit 57 controls the switching unit 15 and the charge-discharge controller 14 so that the power supply unit 11 supplies power to the secondary battery 12. If the amount of charge of the secondary battery 12 becomes equal to or greater than the predetermined value, the charge control unit 57 controls the switching unit 15 and the charge-discharge controller 14 so that the power supply unit 11 stops power supply to the secondary battery 12.

When the receiving unit 51 receives, in the night energy-saving standby mode St032, an energy-saving resume factor as a factor for switching from the night energy-saving standby mode St032 to a different mode, the determining unit 58 determines whether the power supply unit 11 and the commercial power source are connected to each other. In the embodiment, the determining unit 58 determines whether the power supply unit 11 and the commercial power source are connected to each other by determining whether the plug 16 of the power supply unit 11 is plugged in the outlet.

The image-forming-unit control unit 59 controls the operation of the image forming unit 30. Details will be explained below. In the embodiment, when the receiving unit 51 receives a print job, the image-forming-unit control unit 59 performs image processing on print data contained in the received print job. For example, the image-forming-unit control unit 59 converts the print data written in PDL or the like to image data with a format (e.g., a bitmap format) that is printable by the image forming unit 30. The image-forming-unit control unit 59 causes the image forming unit 30 to form an image on a medium, such as a recording sheet, based on the converted image data (to perform printing). In other words, the image forming unit 30 performs printing based on the print data contained in the print job under the control of the image-forming-unit control unit 59.

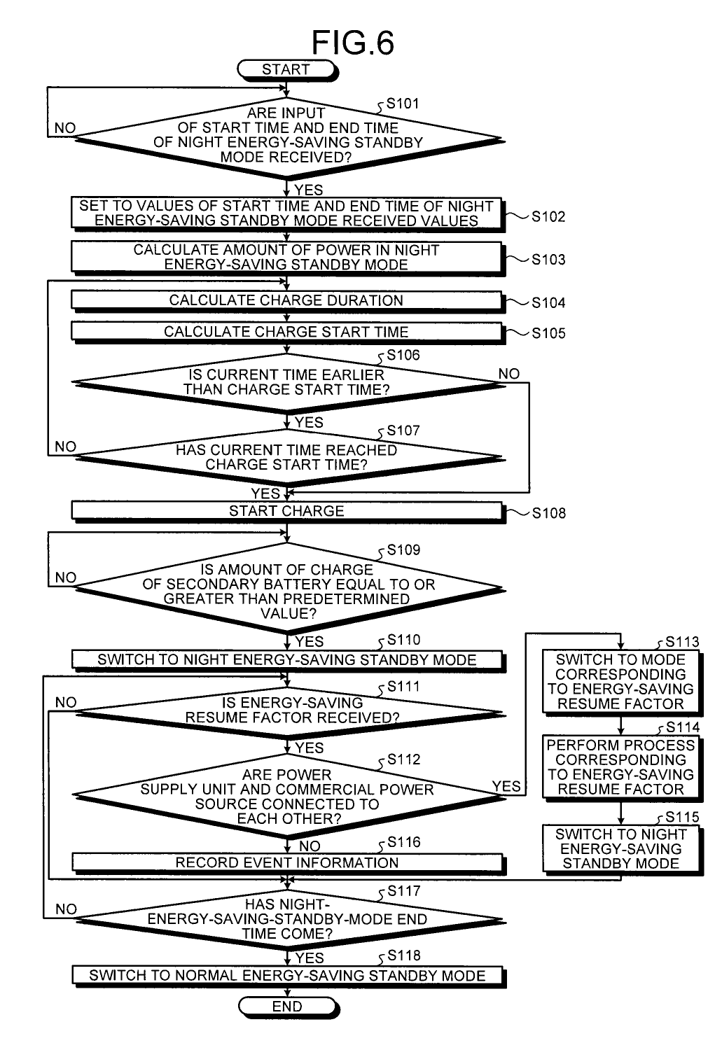

Described below with reference to FIG. 6 is a series of processes from setting of the night-energy-saving-standby-mode start time and the night-energy-saving-standby mode end time to the end of the night energy-saving standby mode. As illustrated in FIG. 6, when the receiving unit 51 receives input of the night-energy-saving-standby-mode start time and the night-energy-saving-standby-mode end time (YES at Step S101), the time setting unit 53 sets the received values to the values of the night-energy-saving-standby-mode start time and the night-energy-saving-standby-mode end time (Step S102). In the embodiment, the values of the night-energy-saving-standby-mode start time and the night-energy-saving-standby-mode end time are input through user's operations of the operating device or user's touch operations of the display panel of the operation display unit 20; however, the method of inputting the values of the night-energy-saving-standby-mode start time and the night-energy-saving-standby-mode end time is not limited thereto and any other method may be used.

The power-consumption calculating unit 54 calculates the night-energy-saving-standby-mode power amount that indicates the amount of power that is consumed when the night energy-saving standby mode St032 is maintained for a duration set by the time setting unit 53 (Step S103). The charge duration calculating unit 55 calculates, based on the current amount of charge of the secondary battery 12 and the amount of power generated by the power generating unit 13, a charge duration indicating a time needed to increase the amount of charge of the secondary battery 12 to a predetermined value that is equal to or greater than the night-energy-saving-standby-mode power amount calculated at Step S103 when the secondary battery 12 is charged by power from the power supply unit 11 (Step S104). The predetermined value can be set to a value that is equal to or greater than the night-energy-saving-standby-mode power amount calculated at Step S103. The charge-start-time calculating unit 56 calculates, as the charge start time indicating a time at which the power supply unit 11 starts charging the secondary battery 12, a time that is earlier than the night-energy-saving-standby-mode start time set at Step S102 by the charge duration calculated at Step S104 (Step S105).

The charge control unit 57 determines whether the current time indicated on the timer 41 is earlier than the charge start time calculated at Step S105 (Step S106). When it is determined that the current time is earlier than the charge start time (YES at Step S106), the process proceeds to Step S107. At Step S107, the charge control unit 57 determines whether the current time indicated on the timer 41 has reached the charge start time. When it is determined that the current time has reached the charge start time (YES at Step S107), the process proceeds to Step S108. On the other hand, when it is determined that the current time has not reached the charge start time (NO at Step S107), the process returns to Step S104.

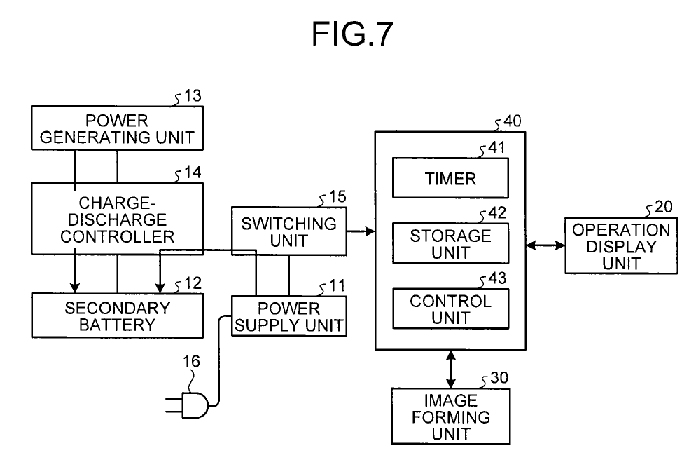

At Step S106, when it is determined that the current time indicated on the timer 41 is later than the charge start time calculated at Step S105 (NO at Step S106), the process proceeds to Step S108. At Step S108, the charge control unit 57 causes the power supply unit 11 to start charging the secondary battery 12. When the secondary battery 12 is charged by power from the power supply unit 11, as illustrated in FIG. 7, the charge control unit 57 controls the switching unit 15 and the charge-discharge controller 14 so that the power supply unit 11 supplies power to the secondary battery 12.

Referring back to FIG. 6, the explanation is continued. After the charge is started at Step S108, the charge control unit 57 determines whether the amount of charge (remaining charge) of the secondary battery 12 is equal to or greater than a predetermined value (Step S109). When determining that the amount of charge of the secondary battery 12 is equal to or greater than the predetermined value (YES at Step S109), the charge control unit 57 controls the switching unit 15 and the charge-discharge controller 14 so that the power supply unit 11 stops power supply to the secondary battery 12. In other words, the charge of the secondary battery 12 by power from the power supply unit is terminated. Thereafter, the mode control unit 52 switches the operating state of the image forming apparatus 100 to the night energy-saving standby mode St032 (Step S110). Specifically, the mode control unit 52 controls the switching unit 15 and the charge-discharge controller 14 so that the power source is switched to the secondary battery 12 and the secondary battery 12 supplies power to only the main controller 40 (see also FIG. 4). The mode control unit 52 may switch the operating state of the image forming apparatus 100 to the night energy-saving standby mode St032 at the same time the charge of the secondary battery 12 is terminated. If the charge of the secondary battery 12 is terminated before the night-energy-saving-standby-mode start time comes, the mode control unit 52 may switch the operating state of the image forming apparatus 100 to the night energy-saving standby mode St032 when the night energy-saving standby mode start time comes.

In the night energy-saving standby mode St032, the control unit 43 determines whether the receiving unit 51 has received the energy-saving resume factor as the factor for switching from the night energy-saving standby mode St032 to a different mode (Step S111). In the embedment, a print job is used as the energy-saving resume factor; however, any type of the energy-saving resume factor may be used. For example, a response received from an external apparatus via a network may be used. When it is determined that the receiving unit 51 has received the energy-saving resume factor (YES at Step S111), the determining unit 58 determines whether the power supply unit 11 and the commercial power source are connected to each other (Step S112). In the embodiment, the determining unit 58 determines whether the power supply unit 11 and the commercial power source are connected to each other by determining whether the plug 16 is plugged in the outlet.

When it is determined that the power supply unit 11 and the commercial power source are connected to each other (YES at Step S112), the mode control unit 52 switches the operating state of the image forming apparatus 100 to the mode corresponding to the received energy-saving resume factor (Step S113). In the embodiment, because the received energy-saving resume factor is the print job, the mode control unit 52 switches the operating state of the image forming apparatus 100 to the normal operating mode St030. Specifically, the mode control unit 52 controls the switching unit 15 and the charge-discharge controller 14 so that the power source is switched to the power supply unit 11 and the power supply unit 11 supplies power to each of the main controller 40 and the image forming unit 30 (see also FIG. 3). After Step S113, the image-forming-unit control unit 59 performs a process corresponding to the received energy-saving resume factor (Step S114). In the embodiment, the image-forming-unit control unit 59 causes the image forming unit 30 to execute the received print job. When the process corresponding to the received energy-saving resume factor is completed, the mode control unit 52 exits the mode corresponding the received energy-saving return mode and switches the operating state of the image forming apparatus 100 back to the night energy-saving standby mode St032 (Step S115). In the embodiment, when the execution of the print job is completed, the mode control unit 52 cancels the normal operating mode St030 and switches the operating state of the image forming apparatus 100 back to the night energy-saving standby mode St032. Thereafter, the process proceeds to Step S117.

On the other hand, at Step S112 described above, when it is determined that the power supply unit 11 and the commercial power source are not connected to each other (NO at Step S112), the mode control unit 52 maintains the night energy-saving standby mode St032 as the operating state of the image forming apparatus 100 and stores event information, in which the contents of the print job received at Step S111 and a reception time are associated with each other, in the storage unit 42 (Step S116). Thereafter, the process proceeds to Step S117.

At Step S117, the mode control unit 52 determines whether the night-energy-saving-standby-mode end time has come. When it is determined that the night-energy-saving-standby-mode end time has not come (NO at Step S117), the process returns to Step S111 described above. On the other hand, when it is determined that the night-energy-saving-standby-mode end time has come (YES at Step S117), the process proceeds to Step S118. At Step S118, the mode control unit 52 switches the operating state of the image forming apparatus 100 to the normal energy-saving standby mode St031. For example, when the amount of charge of the secondary battery 12 just after the night-energy-saving-standby-mode end time is smaller than the reference value, the mode control unit 52 controls the switching unit 15 and the charge-discharge controller 14 so that the power source is switched to the power supply unit 11 and the power supply unit 11 supplies power to only the main controller 40 as illustrated in FIG. 5.

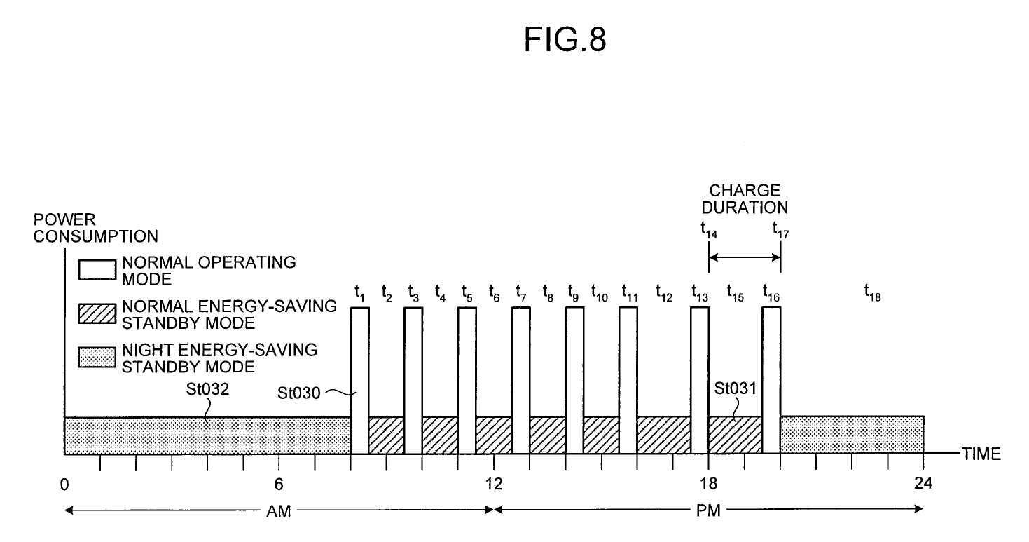

FIG. 8 is a diagram illustrating an example of a change in the operating state of the image forming apparatus 100 over time. A detailed explanation on FIG. 8 is given below. In the example in FIG. 8, a duration of the normal operating mode St030 is 4 hours, the power consumption in the normal operating mode St030 is 1 kW/h, a duration of the normal energy-saving standby mode St031 is 8 hours, the power consumption in the normal energy-saving standby mode St031 is 1 W/h, a duration of the night energy-saving standby mode St032 is 12 hours, and the power consumption in the night energy-saving standby mode St032 is 1 W/h. The night-energy-saving-standby-mode start time is 8:00 p.m. and the night-energy-saving-standby-mode end time is 8:00 a.m. During this period, i.e., the nighttime, the power generating unit 13 does not generate power. During the period other than the nighttime, the power generating unit 13 generates a certain amount of power at 0.4 W/h. The charging rate of the secondary battery 12 by power from the power supply unit 11 is 6 W/h.

A time period t₁ in FIG. 8 is from 8:00 a.m. to 8:30 a.m., during which the operating state of the image forming apparatus 100 is the normal operating mode St030. The amount of charge of the secondary battery 12 at 8:00 a.m. is 6 W. As described above, in the example in FIG. 8, the night energy-saving standby mode St032 is maintained for 12 hours from 8:00 p.m. to 8:00 a.m., so that the power consumption in the night energy-saving standby mode becomes such that 1 W/h×12=12 W. Therefore, the predetermined value described above becomes 18 W, which is obtained by adding 12 W that is the power consumption in the night energy-saving standby mode and 6 W that is standby power.

The charge duration calculating unit 55 calculates a charge duration that is needed to increase the amount of charge of the secondary battery 12 to the predetermined value (18 W) or greater, based on the amount of charge (6 W) of the secondary battery 12 at 8:00 a.m. and the amount of power (0.4 W/h) generated by the power generating unit 13. Because the predetermined value is 18 W and the amount of charge of the secondary battery at 8:00 a.m. is 6 W, the power needed for the charge becomes such that 18 W−6 W=12 W. Furthermore, because the charging rate of the secondary battery 12 by power from the power supply unit 11 is 6 W/h and the amount of power generated by the power generating unit 13 is 0.4 W/h, the charging rate of the secondary battery is calculated as 6.4 W/h. Therefore, the charge duration is calculated such that 12 W/6.4 W≈1 hour 52 minutes. Accordingly, the charge-start-time calculating unit 56 obtains, as the charge start time, 6:08 p.m. that is 1 hour 52 minutes prior to 8:00 p.m. The charge duration calculating unit 55 repeats calculation of the charge duration until the night energy-saving standby mode start time comes. Therefore, the charge duration corresponds to the current amount of charge of the secondary battery 12 and the amount of power generated by the power generating unit 13. Consequently, it becomes possible to improve the calculation accuracy of the charge duration.

In the example in FIG. 8, the power generating unit 13 generates a certain amount of power (0.4 W/h) in the time period other than a time period corresponding to the night energy-saving standby mode St032, and the power source is switched to the power supply unit 11 in the normal operating mode St030. Therefore, the amount of charge of the secondary battery 12 at 8:30 a.m., that is, at the end of the time period t₁, becomes 6.2 W. Accordingly, the power needed for the charge at 8:30 a.m. becomes such that 18 W−6.2 W=11.8 W and the charge duration is calculated such that 11.8 W/6.4 W≈1 hour 50 minutes. As a result, the charge start time is calculated as 6:10 p.m.

A time period t₂ in FIG. 8 is from 8:30 a.m. to 9:30 a.m., during which the operating state of the image forming apparatus 100 is the normal energy-saving standby mode St031. In the example in FIG. 8, the above-mentioned reference value is set to 3 W. The amount of charge of the secondary battery 12 at 8:30 a.m. is 6.2 W, which is greater than the reference value (3 W). Therefore, the power source is switched to the secondary battery 12. Because the power consumption in the normal energy-saving standby mode St031 is 1 W/h and the amount of power generated by the power generating unit 13 is 0.4 W/h, the amount of charge of the secondary battery 12 at 9:30 a.m., which is 1 hour after the start of this time period, becomes such that 6.2−1.0+0.4=5.6 W. Thus, the amount of charge of the secondary battery 12 at 9:30 a.m. is greater than the reference value (3 W). Therefore, the secondary battery 12 is maintained as the power source. The power needed for the charge at 9:30 a.m. is calculated such that 18 W−5.6 W=12.4 W and the charge duration is calculated such that 12.4 W/6.4 W≈1 hour 49 minutes. Therefore, the charge start time is calculated as 6:11 p.m.

A time period t₃ in FIG. 8 is from 9:30 a.m. to 10:00 a.m., during which the operating state of the image forming apparatus 100 is the normal operating mode St030. The power source is switched from the secondary battery 12 to the power supply unit 11, and the amount of charge of the secondary battery 12 at 10:00 a.m. becomes such that 5.6+0.4/2=5.8 W. Therefore, the power needed for the charge is calculated such that 18 W−5.8 W=12.2 W and the charge duration is calculated such that 12.2 W/6.4 W≈1 hour 54 minutes. As a result, the charge start time is calculated as 6:06 p.m.

A time period t₄ in FIG. 4 is from 10:00 a.m. to 11:00 a.m., during which the operating state of the image forming apparatus 100 is the normal energy-saving standby mode St031. The amount of charge of the secondary battery 12 at 10:00 a.m. is 5.8 W, which is greater than the reference value (3 W). Therefore, the power source is switched to the secondary battery 12. The amount of charge of the secondary battery 12 at 11:00 a.m. becomes such that 5.8-1.0+0.4=5.2 W. Therefore, the power needed for the charge at 11:00 a.m. becomes such that 18 W−5.2 W=12.8 W and the charge duration is calculated such that 12.8 W/6.4 W=2 hours. As a result, the charge start time is calculated as 6:00 p.m.

A time period t₅ in FIG. 8 is from 11:00 a.m. to 11:30 a.m., during which the operating state of the image forming apparatus 100 is the normal operating mode St030. The power source is switched from the secondary battery 12 to the power supply unit 11, and the amount of charge of the secondary battery 12 at 11:30 a.m. becomes such that 5.2+0.4/2.5=5.4 W. Therefore, the power needed for the charge at 11:30 becomes such that 18 W−5.4 W=12.6 W and the charge duration is calculated such that 12.6 W/6.4 W≈1 hour 58 minutes. As a result, the charge start time is calculated as 6:02 p.m.

A time period t₆ in FIG. 8 is from 11:30 a.m. to 0:30 p.m., during which the operating state of the image forming apparatus 100 is the normal energy-saving standby mode St031. The amount of charge of the secondary battery 12 at 11:30 is 5.4 W, which is greater than the reference value (3 W). Therefore, the power source is switched to the secondary battery 12. The amount of charge of the secondary battery 12 at 0:30 p.m. becomes such that 5.4-1.0+0.4=4.8 W. Therefore, the power needed for the charge at 0:30 p.m. becomes such that 18 W−4.8 W=13.2 W and the charge duration is calculated such that 13.2 W/6.4 W≈2 hours 3 minutes. As a result, the charge start time is calculated as 5:57 p.m.

A time period t₇ in FIG. 8 is from 0:30 p.m. to 1:00 p.m., during which the operating state of the image forming apparatus 100 is the normal operating mode St030. The power source is switched from the secondary battery 12 to the power supply unit 11, and the amount of charge of the secondary battery 12 at 1:00 p.m. becomes such that 4.8+0.4/2=5.0 W. Therefore, the power needed for the charge at 1:00 p.m. becomes such that 18 W−5.0 W=13.0 W and the charge duration is calculated such that 13.0 W/6.4 W≈2 hours 2 minutes. As a result, the charge start time is calculated as 5:58 p.m.

A time period t₉ in FIG. 8 is from 1:00 p.m. to 2:00 p.m., during which the operating state of the image forming apparatus 100 is the normal energy-saving standby mode St031. The amount of charge of the secondary battery 12 at 1:00 p.m. is 5.0 W, which is greater than the reference value (3 W). Therefore, the power source is switched to the secondary battery 12. The amount of charge of the secondary battery 12 at 2:00 p.m. becomes such that 5.0−1.0+0.4=4.4 W. Therefore, the power needed for the charge at 2:00 p.m. becomes such that 18 W−4.4 W=13.6 W and the charge duration is calculated such that 13.6 W/6.4 W≈2 hours 8 minutes. As a result, the charge start time is calculated as 5:52 p.m.

A time period t₉ in FIG. 8 is from 2:00 p.m. to 2:30 p.m., during which the operating state of the image forming apparatus 100 is the normal operating mode St030. The power source is switched from the secondary battery 12 to the power supply unit 11, and the amount of charge of the secondary battery 12 at 2:30 p.m. becomes such that 4.4+0.4/2=4.6 W. Therefore, the power needed for the charge at 2:30 p.m. becomes such that 18 W−4.6 W=13.4 W and the charge duration is calculated such that 13.4 W/6.4 W≈2 hours 6 minutes. Therefore, the charge start time is calculated as 5:54 p.m.

A time period t₁₀ in FIG. 8 is from 2:30 p.m. to 3:30 p.m., during which the operating state of the image forming apparatus 100 is the normal energy-saving standby mode St031. The amount of charge of the secondary battery 12 at 2:30 p.m. is 4.6 W, which is greater than the reference value (3 W). Therefore, the power source is switched to the secondary battery 12. The amount of charge of the secondary battery 12 at 3:30 p.m. becomes such that 4.6−1.0+0.4=4.0 W. Therefore, the power needed for the charge at 3:30 becomes such that 18 W−4.0 W=14.0 W and the charge duration is calculated such that 14.0 W/6.4 W 2 hours 11 minutes. As a result, the charge start time is calculated as 5:49 p.m.

A time period t₁₁ in FIG. 8 is from 3:30 p.m. to 4:00 p.m., during which the operating state of the image forming apparatus 100 is the normal operating mode St030. The power source is switched from the secondary battery 12 to the power supply unit 11, and the amount of charge of the secondary battery 12 at 4:00 p.m. becomes such that 4.0+0.4/2=4.2 W. Therefore, the power needed for the charge at 4:00 p.m. becomes such that 18 W−4.2 W=13.8 W and the charge duration is calculated such that 13.8 W/6.4 W≈2 hours 9 minutes. As a result, the charge start time is calculated as 5:51 p.m.

A time period t₁₂ in FIG. 8 is from 4:00 p.m. to 5:30 p.m., during which the operating state of the image forming apparatus 100 is the normal energy-saving standby mode St031. The amount of charge of the secondary battery 12 at 4:00 p.m. is 4.2 W, which is greater than the reference value (3 W). Therefore, the power source is switched to the secondary battery 12. The amount of charge of the secondary battery 12 at 5:30 p.m. becomes such that 4.2−1.5+0.4=3.3 W. Therefore, the power needed for the charge at 5:30 p.m. becomes such that 18 W−3.3 W=14.7 W and the charge duration is calculated such that 14.7 W/6.4 W≈2 hours 18 minutes. As a result, the charge start time is calculated as 5:42 p.m.

A time t₁₄ in FIG. 8 is a time at which the charge of the secondary battery 12 by power from the power supply unit 11 is started. For convenience of explanation, the time t₁₄ is set to the charge start time (5:42 p.m.) calculated at 5:30 p.m. When the charge is started, the power supply unit 11 supplies power to the secondary battery 12 via the charge-discharge controller 14. The electric power generated by the power generating unit 13 is also supplied to the secondary battery 12. Therefore, the secondary battery 12 is charged at the charging rate of 6.0 W/h+0.4 W/h=6.4 W/h.

A time period t₁₃ in FIG. 8 is from 5:30 p.m. to 6:00 p.m., during which the operating state of the image forming apparatus 100 is the normal operating mode St030. The power source is switched from the secondary battery 12 to the power supply unit 11. The amount of charge of the secondary battery 12 at 5:42 p.m., which is the charge start time, becomes such that 3.3+0.4×(12/60)=3.38 W. The amount of charge of the secondary battery 12 at 6:00 p.m. becomes such that 3.38+6.4 (18/60)=5.3 W.

A time period t₁₅ in FIG. 8 is from 6:00 p.m. to 7:30 p.m., during which the operating state of the image forming apparatus 100 is the normal energy-saving standby mode St031. The amount of charge of the secondary battery 12 at 6:00 p.m. is 5.3 W, which is greater than the reference value (3 W). However, because the secondary battery 12 is being charged by power from the power supply unit 11, the power supply unit 11 is maintained as the power source. The amount of charge of the secondary battery 12 at 7:30 p.m. becomes such that 5.3+6.4×1.5=14.9 W. The power needed to increase the amount of charge of the secondary battery 12 to the predetermined value (18 W) becomes such that 18.0−14.9=3.1 W. Therefore, if the charge is continued at the charging rate of 6.4 W/h, the amount of charge of the secondary battery 12 reaches the predetermined value in 29 minutes that is obtained such that 3.1/6.4≈29. As a result, 7:59 p.m. is obtained as the charge end time. A time t₁₇ in FIG. 8 is a time at which the charge of the secondary battery 12 by power from the power supply unit 11 is terminated, and is 7:59 p.m. When the amount of charge of the secondary battery 12 becomes equal to or greater than the predetermined value (or the time reaches 7:59 p.m.), the charge control unit 57 controls the switching unit 15 and the charge-discharge controller 14 so that the power supply unit 11 stops power supply to the secondary battery 12.

In the example in FIG. 8, when the time reaches 8:00 p.m., which is the nigh energy-saving standby mode start time, the mode control unit 52 switches the operating state of the image forming apparatus 100 to the night energy-saving standby mode St032. In the example in FIG. 8, the mode control unit 52 does not switch the operating state of the image forming apparatus 100 to the night energy-saving standby mode St032 before the time reaches 8:00 p.m. even when the charge of the secondary battery 12 is terminated before 8:00 p.m. Therefore, during 1 minute between 7:79 p.m. and 8:00 p.m. that is the night energy-saving standby mode start time, only power generated by the power generating unit 13 is supplied to the secondary battery 12.

A time period t₁₆ in FIG. 8 is from 7:30 p.m. to 8:00 p.m., during which the operating state of the image forming apparatus 100 is the normal operating mode St030. The power supply unit 11 is maintained as the power source, and the amount of charge of the secondary battery 12 at 8:00 p.m. becomes such that 18.0+0.4×(1/60) 18.0 W, which is equal to or greater than the predetermined value (18 W).

A time period t₁₈ in FIG. 8 is from 8:00 p.m. to 8:00 a.m. on the following day, during which the operating state of the image forming apparatus 100 is the night energy-saving standby mode St032. The power source is switched to the secondary battery 12 and the amount of charge of the secondary battery 12 at 8:00 a.m. on the following day becomes such that 18.0−1.0×12=6.0 W.

As described above, the image forming apparatus 100 of the embodiment includes the power generating unit 13 that generates power separate from the power supplied by the commercial power source and charges the secondary battery 12 by power generated by the power generating unit 13. Therefore, compared with the configuration in which the power generating unit 13 is not provided, it is advantageous that the power consumption of the commercial power source can be reduced.

In the embodiment, the control unit 43 (the charge duration calculating unit 55) calculates the charge duration indicating a time needed to increase the amount of charge of the secondary battery to a predetermined amount or greater when the secondary battery 12 is charged by power from the power supply unit 11, based on the current amount of charge of the secondary battery 12 and the amount of power generated by the power generating unit 13. Therefore, it becomes possible to improve the calculation accuracy of the charge duration.

Furthermore, in the above embodiment, the power generating unit 13 is constructed of a solar battery. Therefore, in the night energy-saving standby mode St032, the power generating unit 13 does not generate power and does not supply power to the secondary battery 12 (the secondary battery 12 is not charged). Therefore, while it is important to set the amount of charge of the secondary battery 12 at the start of the night energy-saving standby mode St032 to a value that is equal to or greater than the amount of power needed in the night energy-saving standby mode, because the control unit 43 (the charge-start-time calculating unit 56) of the embodiment calculates, as the night energy-saving standby mode start time, the time that is earlier than the night energy-saving standby mode start time by the charge duration, it becomes possible to set the amount of charge of the secondary battery 12 at the start of the night energy-saving standby mode to the predetermined value. As a result, it becomes possible to reliably prevent a situation in which the power supply to the secondary battery 12 becomes impossible in the night energy-saving standby mode St032.

The control program executed by the image forming apparatus 100 of the embodiment as described above may be provided by being recorded in a computer-readable storage medium, such as a CD-ROM, a flexible disk (FD), a CD-R, or a digital versatile disk (DVD), in a computer-installable or a computer-executable format.

The control program executed by the image forming apparatus 100 of the embodiment as described above may be stored in a computer connected to a network, such as the Internet and may be provided by being downloaded via the network. The control program executed by the image forming apparatus 100 of the embodiment as described above may be provided or distributed via a network, such as the Internet.

While the present invention has been explained above, the present invention is not limited to the above embodiment and may be modified in various forms within the scope of the present invention. For example, while a solar battery is used as the power generating unit 13 in the above embodiment, the power generating unit 13 may be configured in an arbitrary manner. For example, a fuel cell system may be employed as the power generating unit 13. It is possible to use, as the power generating unit 13, any means for generating power that is separate from power supplied by the commercial power source.

According to the embodiment of the present invention, it is possible to provide an image forming apparatus that can reduce the power consumption of a commercial power source.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
an image forming unit configured to form an image on a medium;
a control unit configured to control the image forming unit;
a power supply unit configured to supply power from a commercial power source;
a power generating unit configured to generate power that is separate from the power supplied from the commercial power source; and
a secondary battery charged by the power generated by the power generating unit, wherein
the control unit switches a power source between the power supply unit and the secondary battery, the power source supplying power to at least the control unit.

2. The image forming apparatus according to claim 1, further comprising:
a mode control unit configured to control entry to and exit from a first mode that switches does not supply power to the image forming unit with the power source being switched to the secondary battery;
a time setting unit configured to set a first-mode start time indicating a time at which the first mode is entered and a first-mode end time indicating a time at which the first mode is exited;
a power consumption calculating unit configured to calculate a first-mode power consumption indicating an amount of power consumed when the first mode is maintained for a duration set by the time setting unit;
a charge duration calculating unit configured to calculate, based on the amount of charge of the secondary battery and the amount of power generated by the power generating unit, a charge duration indicating a time needed to increase the amount of charge of the secondary battery up to a predetermined value that is equal to or greater than the first-mode power consumption when the secondary battery is charged by the power supplied by the power supply unit;
a charge-start-time calculating unit configured to calculate, as a charge start time indicating a time at which the charge of the secondary battery using the power supplied by the power supply unit starts, a time that is earlier than the first mode start time by the charge duration; and
a charge control unit configured to supply power from the power supply unit to the secondary battery when the charge start time comes, and to stop power supply from the power supply unit to the secondary battery when the amount of charge of the secondary battery becomes equal to or greater than the predetermined value.

3. The image forming apparatus according to claim 2, wherein the power generating unit includes a solar battery.

4. The image forming apparatus according to claim 3, further comprising:
a receiving unit configured to receive an energy-saving resume factor indicating a factor for switching from the first mode to a different mode; and
a determining unit configured to determine whether the power supply unit and the commercial power source are connected to each other when the receiving unit receives the energy-saving resume factor during the first mode, wherein
when the determining unit determines that the power supply unit and the commercial power source are not connected to each other, the mode control unit maintains the first mode, and
when the determining unit determines that the power supply unit and the commercial power source are connected to each other, the mode control unit exits the first mode and switches the mode of the image forming apparatus to a mode corresponding to the energy-saving resume factor.

5. The image forming apparatus according to claim 4, wherein
the energy-saving resume factor contains an image formation request for requesting the image forming unit to form an image,
when the receiving unit receives the image formation request during the first mode, the determining unit determines whether the power supply unit and the commercial power source are connected to each other,
when the determining unit determines that the power supply unit and the commercial power source are connected to each other, the mode control unit exits the first mode and switches the mode of the image forming apparatus to a second mode that supplies power to both of the control unit and the image forming unit with the power source being switched to the power supply unit.

6. A power supply method for an image forming apparatus that includes an image forming unit configured to form an image on a medium, a control unit configured to control the image forming unit, a power supply unit configured to supply power from a commercial power source, a power generating unit configured to generate power that is separate from the power supplied from the commercial power source, and a secondary battery charged by the power generated by the power generating unit, the power supply method comprising:
switching a power source between the power supply unit and the secondary battery, the power source supplying power to at least the control unit.

7. A non-transitory computer-readable storage medium with an executable program stored thereon, wherein the program instructs an image forming apparatus that includes an image forming unit configured to form an image on a medium, a control unit configured to control the image forming unit, a power supply unit configured to supply power from a commercial power source, a power generating unit configured to generate power that is separate from the power supplied from the commercial power source, and a secondary battery charged by the power generated by the power generating unit, to perform:
switching a power source between the power supply unit and the secondary battery, the power source supplying power to at least the control unit.
